(19) United States
(12) Patent Application Publication
(10) Pub. No.: US 2012/0133080 A1
(43) Pub. Date: May 31, 2012

(54) Additive Manufacturing Methods for Improved Curl Control and Sidewall Quality

(75) Inventors: Khalil Moussa, Chapel Hill, NC (US); Hongqing Vincent Wang, Fort Mill, SC (US); Soon-Chun Kuek, Fort Mill, SC (US)

(73) Assignee: 3D Systems, Inc., Rock Hill, SC (US)

(21) Appl. No.: 12/955,408

(22) Filed: Nov. 29, 2010

(51) Int. Cl. B28B 1/14

(52) U.S. Cl. 264/308

(57) ABSTRACT

There is provided methods and apparatus for improving the accuracy of three-dimensional objects formed by additive manufacturing. By depositing or hardening build material within the interior of the layers in certain patterns, the stresses that lead to curl in the object can be isolated and controlled. Similarly, certain patterns for depositing or hardening the build material provide for reduced layer thicknesses to improve the sidewall quality of the object being formed. The patterns within the interior of the layers can include gaps or voids for particular layers being deposited or hardened, and the gaps or voids can be partially filled, fully filled, or not filled at all when subsequent layers are deposited or hardened. Accordingly, the accuracy of three-dimensional objects formed by additive manufacturing is improved.

### FIELD OF THE INVENTION

The present invention is related to additive manufacturing techniques for making three dimensional objects, and more particularly, to methods for improved part quality of the three dimensional objects.

### BACKGROUND OF THE INVENTION

Additive manufacturing, also known as solid freeform fabrication or rapid prototyping/manufacturing, includes many different techniques for forming three-dimensional objects, including but not limited to selective deposition modeling, fused depositing modeling, film transfer imaging, stereolithography, selective laser sintering, and others. For example, selective deposition modeling techniques form three-dimensional objects from computer aided design (CAD) data or other data defining the object to be made by depositing build material in a layer-by-layer fashion to build up the object. Selective deposition modeling, sometimes referred to as 3D printing, is generally described in prior art patents, that include, but are not limited to, U.S. Pat. Nos. 4,999,143; 5,501,824; 5,695,707; 6,133,355; 6,162,378; 6,193,923; and 6,270,335 that are assigned to the assignee of the present application and the disclosures of which are incorporated by reference herein in their entirety.

Additive manufacturing techniques that deposit or harden (cure) a material to form a three-dimensional object often must be carefully controlled to provide the desired accuracy of the object. For example, objects being formed may undesirably curl because of stresses that may be created in the build material used to form the object. Sidewall quality of objects made by additive manufacturing techniques can also be difficult to control given the layer-by-layer approach typically used with additive manufacturing techniques.

Therefore it is desirable to provide methods and apparatus for forming additive manufacturing techniques that provide better accuracy for the three-dimensional object being formed.

### BRIEF SUMMARY OF THE INVENTION

The present invention provides methods and apparatus for improving the accuracy of three-dimensional objects formed by additive manufacturing. Various embodiments of the present invention improve object accuracy by controlling the shape of the material deposited or hardened to minimize or control curl and to improve the side wall quality (the Z-resolution).

Some exemplary methods of the present invention include depositing layers of material that define part interiors with gap patterns that are different for adjacent layers. By providing different gap patterns, the material that is deposited or otherwise hardened is hardened in a way that localizes the stresses created by the hardening process to regions within the part interiors. During the deposition or hardening of a subsequent layer, additional build material may (though not in all embodiments of the present invention) enter the gaps of a previous layer prior to hardening to provide a substantially solid layer. Therefore, certain embodiments of the present invention prevent the accumulation of stresses that cause a three-dimensional object to curl or otherwise deform. Instead, such embodiments isolate the stresses within the part interior. Moreover, further embodiments of the present invention deposit or harden material in manners that selectively control the stresses to create a desired amount of curl or other deformation within the three-dimensional object.

Other exemplary embodiments of the present invention also improve the sidewall quality of the objects by depositing or hardening a layer of build material that defines a part border and void for the part interior. After that layer has hardened, a subsequent layer is provide in such a way that build material enters at least a portion of the void of the previous layer. Accordingly, such embodiments of the present invention enable the deposition or hardening of a layer with less layer thickness than otherwise possible. Such techniques are particularly useful with solid deposition modeling systems, such as three-dimensional printers, that deposit droplets of build material because such techniques enable printing thinner layers when only the part border is printed. For example, three-dimensional printers that planarize or smooth deposited material above a certain height can safely remove the relatively low volume on the part border. Such removal will not damage the planarizer or smoothing device and reduces the amount of build material that is removed. Accordingly, by providing reduced layer thickness, the method provides better sidewall quality.

Various embodiments of the present invention include methods for providing solid part borders and up-facing and down-facing surfaces of the three-dimensional objects being formed in order to provide improved smoothness on the exterior of the object. Within the object, embodiments of the present invention deposit and harden material in different manners to provide gaps and voids in such a way that the object can be formed with better overall accuracy and/or smoothness. These gaps and voids may be temporary (they may be filled with build material when build material is provided for subsequent layers during the build process) or the gaps and voids may be left within the object if such gaps and voids are acceptable (functionally, aesthetically, etc.) to the end user.

Still further aspects of the embodiments of the present invention are described in the detailed description to provide methods and apparatus for forming more accurate three-dimensional objects than provided by conventional additive manufacturing methods and apparatus.

### BRIEF DESCRIPTION OF THE SEVERAL VIEWS OF THE DRAWINGS

Having thus described the invention in general terms, reference will now be made to the accompanying drawings, which are not necessarily drawn to scale and are meant to be illustrative and not limiting, and wherein:

FIG. 1 is a schematic side view of a prior art method of forming three-dimensional objects, wherein the layers of build material are deposited without any gap patterns or voids;

FIGS. 2A, 2B, and 2C illustrates one embodiment of the present invention and includes schematic top views of a first layer (N), a second layer (N+1), and a third layer (N+2), respectively, that define different gap patterns within the respective first, second, and third part interiors and wherein the gap patterns define respective grids oriented along the x-axis and y-axis and that define substantially the same shape but are shifted along the x-axis and y-axis relative to one another;

FIG. 3 illustrates an enlarged schematic top view of a gap pattern similar to the gap pattern of FIG. 2C and showing the individual pixels or droplets of build material defining the part border (the solid border) and the part interior having a gap oriented along the x-axis and a gap oriented along the y-axis, wherein the gaps are two pixels wide along the x-axis gap and are three pixels wide along the y-axis;

FIG. 4 illustrates a further embodiment of the present invention with a side schematic view of three layers of build material deposited in the build area, wherein the first layer (N) defines two gaps, the second layer (N+1) defines three gaps, and the third layer (N+2) defines two gaps, wherein the gaps are shifted relative to gaps in the other layers, and wherein build material from the second layer fills the gaps in the first layer and build material from the third layer fills the gaps in the second layer;

FIG. 5 illustrates two objects (towers) made from a build material, wherein the object on the left was made using the present invention and exhibits less undesired curvature relative to the object on the right made with conventional methods of forming a three-dimensional object without gap patterns or voids;

FIG. 6A illustrates three objects (bars) made from build material, wherein the top bar was made with conventional methods, the middle bar was made in accordance with one embodiment of the present invention and included gap patterns in the part interiors of the layers, in which the gap patterns were not filled with build material to leave voids in the part interiors, and the bottom bar was made in accordance with a second embodiment of the present invention and included gap patterns in the part interiors of the layers, in which the gap patterns were filled with build material of subsequent layers to remove voids in the part interiors, wherein the top bar exhibits some undesired curvature and the middle and bottom bars do not exhibit undesired curvature;

FIG. 6B illustrates an enlarged view of the middle bar of FIG. 6A to show the small voids in the part interior visible through the semi-transparent build material, wherein the portions of layers that define the up-facing and down-facing surfaces of the three-dimensional object are free of a gap pattern to provide solid borders on all exterior surfaces of the object;

FIG. 7 illustrates a side schematic view in accordance with a further embodiment of the present invention, wherein the first layer (Layer N) defines a first part border and a first part interior, the second layer (Layer N+1) defines a second part border and a second part interior, in which the second part interior is substantially free of build material to define a second layer void, the third layer (Layer N+2) defines a third part border and a third part interior, in which the third part interior is divided into a plurality of regions (not shown) having one or more gaps (not shown) between regions and in which build material deposited for the third part interior substantially fills the second layer void, and a fourth layer (Layer N+3) defines a fourth part border and a fourth part interior, in which the fourth part interior is substantially free of build material to define a fourth layer void;

FIG. 8A illustrates a side schematic view of a first layer of build material (Layer N) deposited on a layer of support material in accordance with an embodiment of the present invention, wherein the first layer of build material defines a down-facing surface of the three-dimensional object and is free of a gap pattern;

FIG. 8B illustrates a side schematic view of a second layer of build material (Layer N+1) deposited on the first layer of build material shown in FIG. 8A, wherein the second layer of build material defines a second part border and a second part interior and wherein the second part interior is substantially free of build material deposited for the second layer to define a second layer void;

FIG. 8C illustrates a top schematic view of a third layer of build material deposited on a second layer defining a second layer void, such as for example the second layer of build material shown in FIG. 8B, wherein the third layer of build material defines a third part border (comprising a width of two pixels) and a third part interior divided into a plurality of regions (the part pattern) having gaps between the regions, wherein the gaps define a third gap pattern;

FIG. 8D illustrates a top schematic view of a fourth layer of build material deposited on the third layer, of build material shown in FIG. 8C, wherein the fourth layer of build material defines a fourth part border and a fourth part interior and wherein the fourth part interior is substantially free of build material deposited for the fourth layer to define a fourth layer void;

FIG. 9A illustrates a top schematic view of a first layer of build material deposited in accordance with one embodiment of the present invention, wherein the first layer of build material defines a first part border (comprising a width of about two to five pixels) and a first part interior divided into a plurality of regions having gaps between the regions, wherein the gaps define a first gap pattern; and

FIG. 9B illustrates a top schematic view of a second layer of build material deposited on the first layer of build material shown in FIG. 9A, wherein the second layer of build material defines a second part border and a second part interior and wherein the second part interior is substantially free of build material deposited for the second layer to define a second layer void.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the methods and apparatus are described and shown in the accompanying drawings with regard to a three-dimensional printing apparatus, it is envisioned that the methods and apparatus of the present invention may be applied to any now known or hereafter devised additive manufacturing process in which improved part accuracy and smoothness is desired. Like numbers refer to like elements throughout.

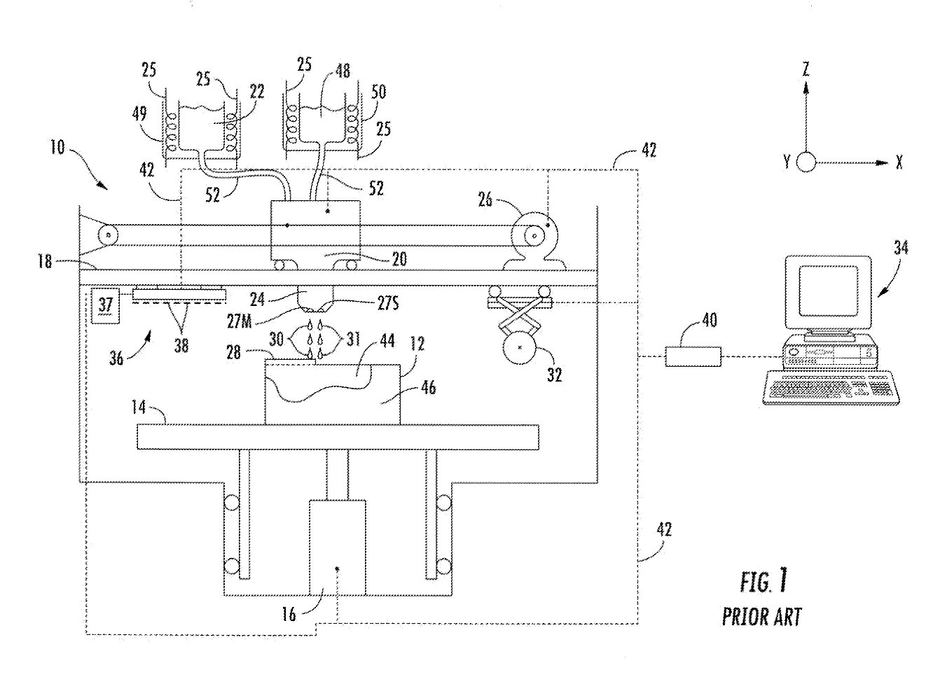

Turning first to a conventional solid deposition modeling (SDM) technique, FIG. 1 is a schematic diagram of an SDM apparatus 10 building a three-dimensional object 44 on a support structure 46 in a build area 12. The object 44 and support structure 46 are built in a layer by layer manner on a build platform 14 that can be precisely positioned vertically by any conventional actuation device 16, which in FIG. 1 generally comprises a pneumatic or hydraulic cylinder, but in further embodiments may comprise any actuation device that raises and lowers the build platform. Directly above and parallel to the platform 14 is a rail system 18 on which a material dispensing trolley 20 resides carrying a dispensing device 24. In certain embodiments of the present invention, the dispensing device 24 is an ink jet print head that dispenses a build material and support material and is of the piezoelectric type having a plurality of dispensing orifices. However, other ink jet print head types could be used, such as an acoustic or electrostatic type, if desired. Alternatively, a thermal spray nozzle could be used instead of an ink jet print head, if desired. An example dispensing device 24 is the aforementioned piezoelectric Z850 print head. The material dispensed from the Z850 print head desirably has a viscosity of between about 13 to about 14 centipoise at a dispensing temperature of about 80° C. The dispensing methodology of this system is described in greater detail in U.S. patent application Ser. No. 09/971,337 assigned to the assignee of the present invention. Further embodiments of the present invention comprise alternative dispensing devices. Still further embodiments of the present invention include alternative additive manufacturing techniques that do not comprise dispensing devices of the type described above but instead dispense material from a nozzle (such as fused deposition modeling) or selectively harden layers of material (such as with stereolithography and film transfer imaging) and the like.

The trolley 20 of FIG. 1 carrying the dispensing device 24 is fed the curable phase change build material 22 from a remote reservoir 49. The remote reservoir is provided with heaters 25 to bring and maintain the curable phase change build material in a flowable state. Likewise, the trolley 20 carrying the dispensing device 24 is also fed the non-curable phase change support material 48 from remote reservoir 50 in the flowable state. In order to dispense the materials, a heating device is provided to initially heat the materials to the flowable state, and to maintain the materials in the flowable state along its path to the dispensing device. In an example embodiment, the heating device comprises heaters 25 on both reservoirs 49 and 50, and additional heaters (not shown) on the umbilicals 52 connecting the reservoirs to the dispensing device 24.

Located on the dispensing device 24 are discharge orifices 27M and 275 for respectively dispensing build material 30 and support material 31. Discharge orifices 27M and 275 are adapted to dispense their respective materials to any desired target location in the build area 12.

The dispensing device 24 is reciprocally driven on the rail system 18 along a horizontal path (i.e., along the X-axis) by a conventional drive device 26 such as an electric motor. In some embodiments of the present invention, the trolley carrying the dispensing device 24 takes multiple passes to dispense one complete layer of the materials from discharge orifices 27M and/or 27S.

Layers 28 are sequentially deposited to form object 44. In FIG. 1, a portion of a layer 28 of dispensed build material 30 is shown as the trolley has just started its pass from left to right. FIG. 1 shows the formation of an uppermost layer 28. A bottom-most layer 28 (not shown) resides adjacent platform 14. Dispensed build-material droplets 30 and support material droplets 31 are shown in mid-flight, and the distance between the discharge orifice and the layer 28 of build material is greatly exaggerated for ease of illustration. The layer 28 may be all build material, all support material, or a combination of build and support material, as needed, in order to form and support the three-dimensional object.

The build material and support material are dispensed as discrete liquid droplets in the flowable state, which solidify upon contact with the layer 28 as a result of a phase change. Alternatively, the materials may be dispensed in a continuous stream in an SDM apparatus, if desired. Each layer 28 of the object 44 is divided into a plurality of pixels on a bit map, in which case a target location is assigned to the pixel locations of the object for depositing the curable phase change material 22. Likewise, pixel coordinates located outside of the object may be targeted for deposition of the non-curable phase change support material 48 to form the supports for the object 44 as needed. Generally, once the discrete liquid droplets are deposited on all the targeted pixel locations of the bit map for a given layer, the dispensing of material for forming the layer is complete, and an initial thickness of layer 28 is established. In certain embodiments of the present invention, the initial layer thickness is greater than the final layer thickness.

A planarizer 32 is then drawn across the layer to smooth the layer and normalize the layer to establish the final layer thickness, as known in the art. The planarizer 32 is used to normalize the layers as needed in order to eliminate the accumulated effects of drop volume variation, thermal distortion, and the like, which occur during the build process. It is the function of the planarizer to melt, transfer, and remove portions of the dispensed layer of build material in order to smooth it out and set a desired thickness for the last formed layer prior to curing the material. This ensures a uniform surface topography and layer thickness for all the layers that form the three-dimensional object and the support structure. However, it produces waste material that must be removed from the system. The planarizer 32 may be mounted to the material dispensing trolley 20, if desired, or mounted separately on the rail system 18 (as shown in FIG. 1). Alternatively, the layers can be normalized by utilizing capillary action to remove excess material, as disclosed in U.S. patent application Ser. No. 09/754,870, assigned to the assignee of the present invention, or an active surface scanning system that provides feedback data that can be used to selectively dispense additional material in low areas to form a uniform layer as disclosed in U.S. patent application Ser. No. 09/779,355, also assigned to the assignee of the present invention.

A waste collection system (not shown in FIG. 1) is used to collect the excess material generated during planarizing. The waste collection system may comprise an umbilical that delivers the material to a waste tank or waste cartridge, if desired. A waste system for curable phase change materials is disclosed in U.S. patent application Ser. No. 09/970,956, assigned to the assignee of the present invention.

In an example embodiment, the UV curing system 36 of the present invention is mounted on rail system 18. The UV curing system 36 is reciprocally driven along rail system 18 so that it can irradiate a just-dispensed layer of material onto object 44 or support structure 46. The UV curing system 36 includes at least one and, in certain embodiments, a plurality of UV light-emitting diodes (LEDs) 38 which is/are used to provide a planar (flood) exposure of relatively narrow-band UV radiation to each layer as needed.

The UV exposure is executed in a continuous (i.e., non-pulsed) manner, with the planarizer retracted from the build area when the continuous exposure occurs. Although the UV curing system 36 is shown reciprocally mounted on rail system 18, it may be mounted directly on the dispensing trolley, if desired. It is important to shield the dispensing device and planarizer from exposure to UV radiation by the UV curing system so as to prevent curing of material in the dispensing orifices or on the surface of the planarizer, either of which would ruin the build process and damage the apparatus.

With continuing reference to FIG. 1, an external computer 34 generates or is provided with (e.g., via a computer-readable medium) a solid modeling CAD data file containing three-dimensional coordinate data of an object to be formed. Typically the computer 34 converts the data of the object into surface representation data, most commonly into the STL file format. In certain embodiments of the present invention, the computer also establishes data corresponding to support regions for the object. When a user desires to build an object, a print command is executed at the external computer in which the STL file is processed, through print client software, and sent to the computer controller 40 of the SDM apparatus 10 as a print job. The processed data transmitted to the computer controller 40 can be sent by any conventional data transferable medium desired, such as by magnetic disk tape, microelectronic memory, network connection, or the like. The computer controller processes the data and executes the signals that operate the apparatus to form the object. The data transmission route and controls of the various components of the SDM apparatus are represented as dashed lines at 42.

Once the three-dimensional object 44 is formed, the support material 48 from support structure 46 is removed by further processing. Generally, application of thermal heat to bring the support material back to a flowable state is needed to remove substantially all of the support material from the three-dimensional object. This can be accomplished in a variety of ways. For example, the part can be placed in a heated vat of liquid material such as in water or oil. Physical agitation may also be used, such as by directing a jet of the heated liquid material directly at the support material. This can be accomplished by steam cleaning with appropriate equipment. Alternatively, the support material can also be removed by submersing the material in an appropriate liquid solvent to dissolve the support material. Specific details on support material removal are disclosed in U.S. patent application Ser. No. 09/970,727 and U.S. patent application Ser. No. 10/084,726, both of which are assigned to the assignee of the present invention.

The conventional SDM apparatus 10 disclosed in FIG. 1 deposits the layers 28 of build material in cross-sectional patterns of the three-dimensional object 44 being formed. The layers 28 of FIG. 1 are solid layers that do not define any gaps or voids. Accordingly, as the deposited build material 30 hardens, it may change shape (such as shrink) and create stresses within the layer. These stresses may lead to undesirable curling or other deformation of the layer and/or the resulting object, particularly for objects with relatively long and/or thin portions that provide relatively minimal resistance to curling or other deformation. Therefore, conventional SDM methods, and similarly other additive manufacturing methods that allow the accumulation of stresses to cause undesirable curl or other deformations, can produce objects that do not exhibit the desired accuracy (such as the object on the right-hand side of FIG. 5, as discussed below). Certain embodiments of the present invention overcome these difficulties by providing gap patterns within the part interiors of the layers being deposited to prevent or minimize the accumulation of stress within the layers and the resulting object.

The SDM methods discussed above and illustrated in FIG. 1 also may provide sidewall quality that is less smooth than desired by certain customers. Such relative poor Z-resolution (sidewall smoothness) is typically a function of the minimum layer thickness possible for the particular SDM apparatus 10. The minimum layer thickness of the SDM apparatus 10 is often a function of the drop mass of the individual droplets deposited from the dispensing device 24. One possible technique for reducing layer thickness (and improve Z-resolution) is to adjust the position of the planarizer 32 relative to the dispensed layer in order to remove more of the build material defining the particular layer to accordingly reduce the thickness of the layer. However, such techniques can have undesirable side effects such as (1) wasting significantly more build material that is removed by the planarizer 32; (2) reducing the resolution or accuracy (along the x- and y-axes) of the layer by pushing, such as by snow-plowing and the like, build material onto areas where build material is not desired; (3) leaving more build material on the layer than desired because the planarizer is unable to remove the desired quantity of build material; and (4) damaging the wiper blade (not shown in FIG. 1) that removes material from the planarizer because of the excessive material on the planarizer, especially if such build material is solid or semi-solid. Alternative techniques for reducing layer thickness include using dispensing devices that dispense smaller droplets of material; however, such dispensing devices can significantly increase the build time for forming a three-dimensional object which increases the production costs (through more energy and less throughput) of the objects formed. Certain embodiments of the present invention overcome these difficulties by providing voids within the part interiors of certain layers being deposited so that only a part border is deposited for such layers so that the planarizer is able to remove the significantly less excess material for that particular layer and thus provide a thinner layer thickness, as discussed more fully below.

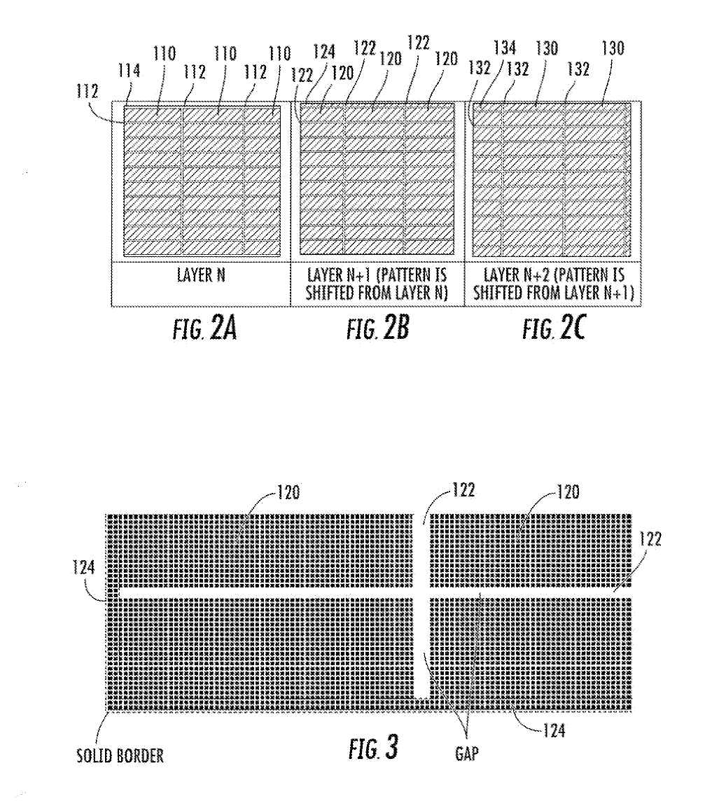

Turning now to FIGS. 2A to 2C, one embodiment of the present invention is shown in which three sequential layers are shown from above. The three layers—the first layer (Layer N) of FIG. 2A; the second layer (Layer N+1) of FIG. 2B; and the third layer (Layer N+2) of FIG. 2C-all define a respective part border and a respective part interior, wherein the part interiors are divided into a plurality of regions having one or more gaps between the regions. The one or more gaps between the regions define gap patterns for the respective layers. The first layer of FIG. 2A, which is deposited in a build area, defines a first part interior with regions 110 having gaps 112 between the regions. Surrounding the first part interior is a first part border 114 that will define the exterior of the object being formed. The one or more gaps 112 between the regions define a first gap pattern. The first gap pattern of FIG. 2A defines a grid that is substantially oriented along the x-axis and the y-axis (FIG. 2A is viewed from above, along the z-axis). However further embodiments of the present invention include gaps of the gap pattern that define shapes such as circles, polygons, and other random or repeating configurations. The present invention includes the use of any shapes of gap patterns in any sequence along the layers of an object.

Similarly, the second layer of FIG. 2B, which is deposited on the first layer of FIG. 2A, defines a second part interior with regions 120 having gaps 122 between the regions. Surrounding the second part interior is a second part border 124 that will define the exterior of the object being formed. The one or more gaps 122 between the regions define a second gap pattern. The second gap pattern of FIG. 2B defines a grid that is substantially oriented along the x-axis and the y-axis, similar to the first layer. However, the second gap pattern is different than the first gap pattern, even though the first gap pattern defines substantially the same shape as the second gap pattern, because the second gap pattern is shifted along both the x-axis and the y-axis relative to the first gap pattern (of course, the first gap pattern could equally be considered shifted relative to the second gap pattern).

By depositing the first and second layers with gap patterns, the respective gaps allow the internal stresses generated during hardening to become localized within the individual regions and not accumulate in such a way that could adversely affect the entire layer or object (such as by inducing curl or other deformation). After the first layer has been substantially hardened with the gaps of the gap pattern, the second layer is deposited on the first layer, and in some embodiments of the present invention the build material deposited for the second layer enters into one or more gaps defining the gap pattern thereby filling the gaps to provide a substantially solid first layer. Of course, if gaps provided in the first and second layers overlap, such overlapping portion of the gaps may not be filled until subsequent layers that may deposit build material above (and into) the overlapping gap. In such embodiments, the UV LEDs or other curing device (if the build material is not phase change material that does not require radiation to harden) preferably, though not necessarily, are able to cure the build material in the first layer through the second layer (or through the third or subsequent layers for situations with overlapping gaps).

Still further embodiments of the present invention provide gaps in the first layer that are substantially free of build material deposited for the second layer or other subsequent layers. These gaps, or voids, free of build material in the final object can be achieved by providing gaps sized so that build material does not enter them because of surface tension or trapped volumes of air or because of the geometries of the gaps relative to the gaps provided in the layers above and/or below. Such embodiments of the present invention intentionally leave gaps or voids free of build material in the final object for any of a number of reasons, which include but are not limited to (1) reducing the amount of build material required to form the object, (2) controlling stresses in such a manner to induce desired curl or other deformation, and (3) providing variable material properties or performance characteristics to certain portions of the final object (for example, providing more or less rigidity in certain portions based upon the number and size of unfilled gaps in the respective portions). Of course, purposes such as (2) and (3) and others can be achieved by filling the gaps with build material deposited for subsequent layers. Yet further embodiments of the present invention allows some build material to enter gaps of previous layers but does not provide so much build material that the gaps are substantially filled.

In some embodiments of the present invention, the build process may include only two different gap patterns, namely the first and second gap patterns, such that second layers are repeatedly deposited on first layers and first layers are repeatedly deposited on second layers until the three-dimensional object is formed. In certain of these embodiments, preventing overlaps of gaps is required if gaps in the previous layers are desired to be filled and/or if gaps extending along the z-axis are not desired.

Other embodiments of the present invention provide a third layer, such as the third layer of FIG. 2C, which is deposited on the second layer of FIG. 2B. The third layer defines a third part interior with regions 130 having gaps 132 between the regions. Surrounding the third part interior is a third part border 134 that will define the exterior of the object being formed. The one or more gaps 132 between the regions define a third gap pattern. The third gap pattern of FIG. 2C defines a grid that is substantially oriented along the x-axis and the y-axis, similar to the first and second layers. However, the third gap pattern is different than the first and second gap patterns, even though they define substantially the same shape as the third gap pattern, because the third gap pattern is shifted along both the x-axis and the y-axis relative to the first and second gap patterns similar to the shifting of the first and second gap patterns relative to one another. The shifting of the gap patterns in the first, second, and third layers is such that no overlapping gaps remain after the third layer.

FIG. 3 is an enlarged view of the second part border 124 and second gap pattern of the second layer of FIG. 2B. FIG. 3 shows the individual pixels or droplets (a droplet is deposited for each pixel of electronic data in the illustrated embodiment) defining the second part border 124, the regions 120 of the second part interior, and the gaps 122 of the second gap pattern. The second part border 124 comprises two pixels, as shown at the left side of the x-axis gap 122 and at the bottom of the y-axis gap 122. The gaps 122 of FIG. 3 define different widths, with the x-axis gap defining a width of two pixels and the y-axis gap defining a width of three pixels. The width, location, shape, etc. of the gaps of the gap patterns are preferably determined automatically by software implementing the methods of the present invention or the gaps can be manually set by operators of the additive manufacturing system implementing the methods of the present invention. Such automated software may be programmed with certain algorithms or calculations to determine the preferred location, size, shape, etc. of the gaps to achieve the desire elimination or control of curl or other distortions.

Because the methods and apparatus of the present invention are typically practiced in a manner that does not affect the overall accuracy of the object being formed, most (but not all) embodiments of the present invention determine the portions of the various layers that define up-facing and down-facing surfaces of the three-dimensional object being formed. The up-facing and down-facing portions of the layers are deposited such that the portions are free of gap patterns to prevent such gaps from being present on the surface of the object. Indeed, certain embodiments of the present invention eliminate gap patterns two or more layers below or above the up-facing surfaces and down-facing surfaces, respectively, to ensure that no artifacts of the gaps are present on the exterior surfaces of the three-dimensional object.

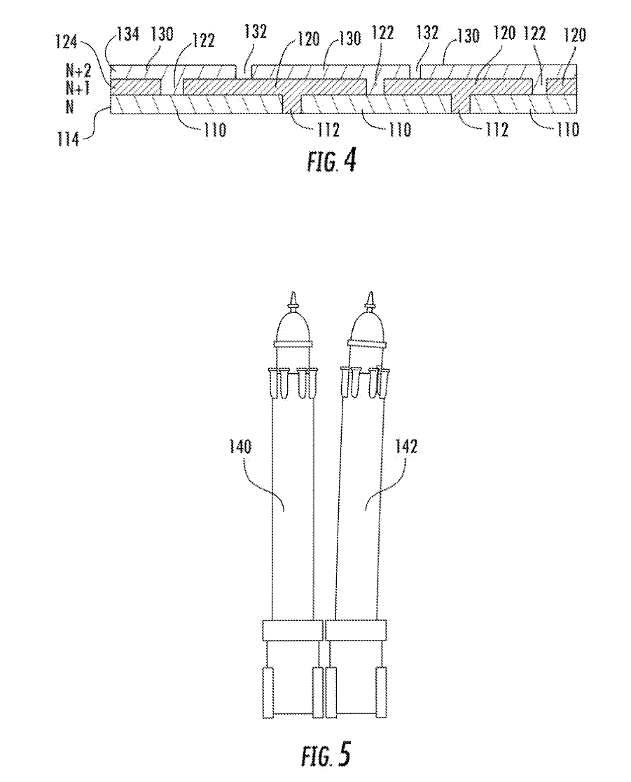

FIG. 4 illustrates a further embodiment of the present invention with a side schematic view of three layers of build material deposited in the build area, such as the first, second, and third layers of FIGS. 2A through 2C. The first layer (N) defines two gaps 112, the second layer (N+1) defines three gaps 122, and the third layer (N+2) defines two gaps 132. The gaps are shifted relative to gaps in the other layers as discussed above. As shown in FIG. 4, the build material from the second layer fills the gaps 112 in the first layer and build material from the third layer fills the gaps in the second layer 122. The gaps 132 of the third layer are not yet filled because a fourth layer has not yet been deposited.

The results of one embodiment of the present invention is shown in FIG. 5 when compared to the result of the prior art techniques. The object 140 on the left is a tower made in accordance with one embodiment of the present invention. Because the height of the tower is greater that the z-axis build area of the SDM apparatus that formed the object 140 and to enable faster production of the object, the tower was formed on its side with the height of the tower oriented along the x-axis (the axis of travel of the dispensing device 24 relative to the platform 14, which is the longest axis of the build area for the SDM apparatus used with this embodiment). The object 140 is very straight, as designed in the CAD file used to make the object. Conversely, the object 142 on the right of FIG. 5 exhibits significant undesirable curvature because the object 142 was formed in accordance with prior art techniques. Because no gap patterns were provided in the object 142, the stresses generated along the height of the tower (along the x-axis during formation) caused the tower to undesirably curl. Such an amount of curvature would typically cause the operator or end customer to consider the object 142 a failure, whereas the object 140 would be considered a successful representation of the CAD file.

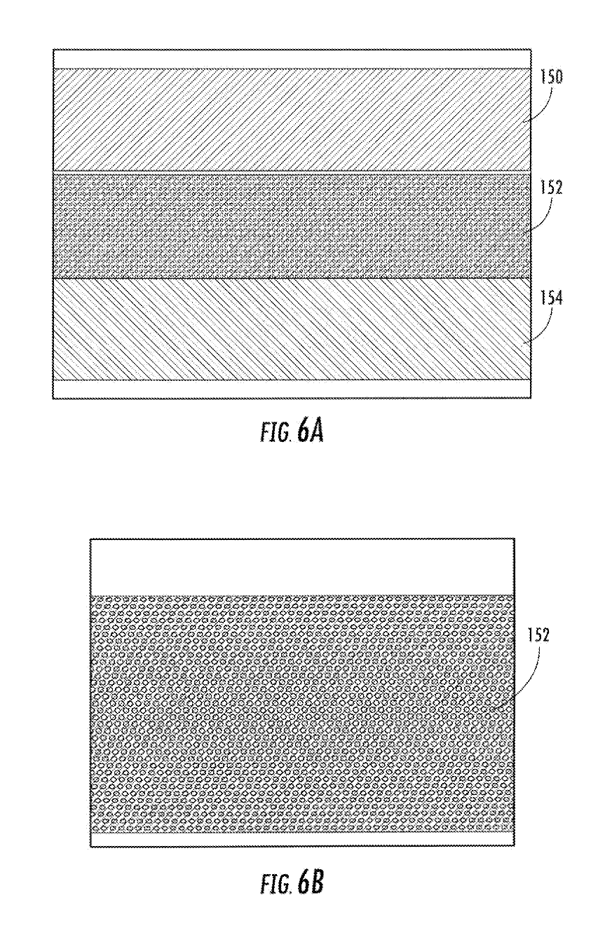

Similar to FIG. 5, FIG. 6A illustrates three bars made from build material. The top bar 150 was made with conventional methods and exhibits a slight amount of undesired curvature. The middle bar 152 was made in accordance with one embodiment of the present invention and includes gap patterns in the part interiors of the layers. The gap patterns of bar 152 were not filled with build material to leave voids in the part interiors, as can be seen in FIG. 6A. The bottom bar 154 was made in accordance with another embodiment of the present invention and includes gap patterns in the part interiors of the layers. The gap patterns of bar 154 were filled with build material of subsequent layers to remove voids in the part interiors. Bars 152 and 154 do not exhibit undesired curvature. FIG. 6B illustrates an enlarged view of bar 152 of FIG. 6A to show the small voids in the part interior visible through the semi-transparent build material. It should be noted that the up-facing and down-facing surfaces of the three-dimensional object 152 are free of a gap pattern to provide smooth, solid borders on all exterior surfaces of the object 152.

FIG. 7 illustrates yet another embodiment of the present invention wherein the part interiors for certain layers are substantially free of build material to define a void. By providing voids in the part interior, the present invention allows the layer thickness for such layers to be reduced. By reducing the layer thicknesses, the embodiment of FIG. 7 and similar embodiments provide for improved sidewall quality and smoothness. The first layer 160 (Layer N) of FIG. 7 is deposited in a build area, defines a first part border and a first part interior with regions having gaps between the regions. The one or more gaps 112 between the regions define a first gap pattern similar to the embodiment discussed above. It should be noted that the references to a first layer for this embodiment and other embodiments herein should not be limited to mean the first layer of build material deposited by the SDM or other apparatus, but simply the first layer discussed herein. The “first layer” described herein could be any layer within the object that has one or more additional layers of material deposited on it.

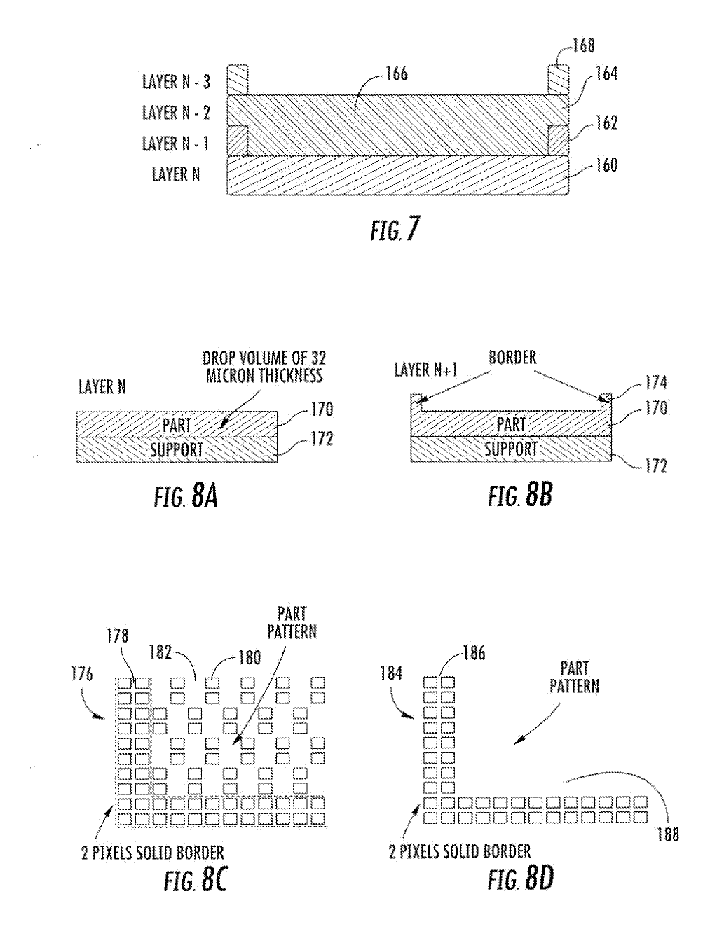

The second layer 162 (Layer N+1) of FIG. 7 is deposited on the first layer 160 and defines a second part border and a second part interior. The second part interior is substantially free of build material deposited for the second layer and defines a second layer void. The layers of FIG. 7 are not to scale, but it should be understood that the second layer 162 of FIG. 7 can be about half the thickness of the first layer 160 (similar to layers 170 and 172 discussed below for FIGS. 8A and 8B) because the planarizer is capable of removing thickness from the second part border. Given the relatively larger volume of material for part interiors (even when gap patterns are provided) the planarizer of certain embodiments of the present invention would not be able to reduce the thickness of layer with material in the part interior without adversely affecting the layer quality or accuracy.

After layer 162 has been hardened, the third layer 164 (Layer N+2) is deposited on the second layer. The third layer 164 defines a third part border and a third part interior 166 that is divided into a plurality of regions having one or more gaps (not shown) between the regions. The one or more gaps between the regions defines a third gap pattern. The build material deposited for the third part interior 166 substantially fills the second layer void and is deposited on the first part interior. Although the phrase “substantially fills the second layer void” is used herein and in the claims, it should be understood that the build material in the second layer void includes the same gap pattern as the third part interior and still substantially fills the second layer void. In some embodiments of the present invention represented by FIG. 7, the third gap pattern is different than the first gap pattern, such that the gaps in the first gap pattern are substantially or partially filled with build material deposited with the third layer 164.

It should be appreciated that in embodiments of the present invention of the type illustrated in FIG. 7, that when the build material deposited for second layer 162 was first deposited, it defined the height approximately equal to the combined height of second and third layers 162 and 164 because of the drop mass limitation of the SDM apparatus. Deposited material above the desired height of the second layer 162 can be planarized or smoothed. While depositing the build material for the third layer 164, the drops above the second layer 162 may initially extend substantially above the third layer because of the presence of the second layer; however, such additional material (the amount will be determined by the minimum drop mass possible from the dispensing device) will be present only above the third part border and will be an amount small enough to be reliably planarized without adversely affecting the layer or object.

FIG. 7 further shows a fourth layer 168 deposited on the third layer. The fourth layer defines a fourth part border and a fourth part interior. The fourth part interior, like the second part interior, is substantially free of build material deposited for the fourth layer to define a fourth layer void. Like the second layer, the fourth part border can be planarized to define a thickness approximately half of the thickness of conventional forming techniques used on the same SDM apparatus. A fifth layer (not shown), may then be deposited on the fourth layer, similar to how the third layer was deposited on the second layer, and the process is repeated until the object is formed (or at least until the up-facing portions of the build are approached). Of course, the up-facing and down-facing surfaces of the three-dimensional object made using the methods shown in FIG. 7 are free of gap patterns, as discussed above, to provide accurate, smooth exterior surfaces of the desired object. In further embodiments of the present invention similar to the embodiment of FIG. 7, the layers define part borders in a two-part process in which an initial part border is deposited (similar to the second layer of FIG. 7) and substantially hardened prior to a subsequent part border (similar to the third part border of FIG. 7) is deposited on the initial part border.

FIGS. 8A through 8D illustrate embodiments similar to FIG. 7 but include top views similar to FIG. 3. FIG. 8A shows a first layer 170 (Layer N) of build material deposited on a layer of support material 172. The first layer of build material defines a down-facing surface of the three-dimensional object and is free of a gap pattern. FIG. 8B shows a second layer 174 (Layer N+1) of build material deposited on the first layer of build material shown in FIG. 8A. The second layer of build material defines a second part border and a second part interior. The second part interior is substantially free of build material deposited for the second layer to define a second layer void, similar to the second layer 162 of FIG. 7. FIG. 8C shows a third layer 176 of build material deposited on the second layer (not shown in FIG. 8C). The third layer 176 of build material defines a third part border 178 (comprising a width of two pixels) and a third part interior divided into a plurality of regions 180 (the part pattern) having gaps 182 between the regions. The gaps 182 define a third gap pattern. The third part interior extends down to the first layer 170 and substantially fills the second layer void similar to the third part interior 166 discussed above. FIG. 8D shows a fourth layer 184 of build material deposited on the third layer 176 shown in FIG. 8C (the third part interior is not shown in FIG. 8D for clarity). The fourth layer 184 of build material defines a fourth part border 186 and a fourth part interior 188. The fourth part interior 188 is substantially free of build material deposited for the fourth layer to define a fourth layer void.

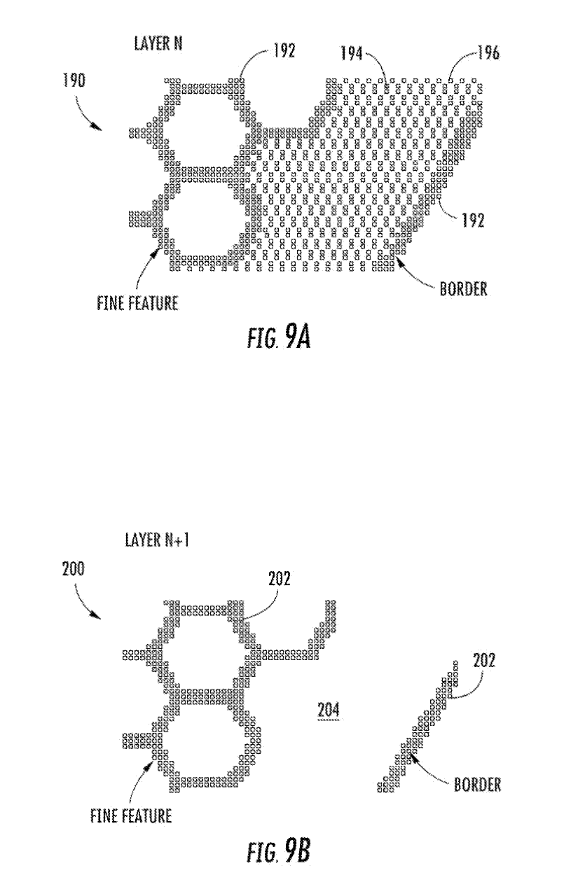

FIGS. 9A and 9B show yet another embodiment of the present invention. FIG. 9A shows a first layer 190 of build material (Layer N) deposited in a build area. The first layer 190 defines a first part border 192 that comprises a width of about two to five pixels depending upon the location of the first part border. The first part border 192 includes the fine features on the left side and an angled, straight wall on the right side. Between the left and right sides of the first part border 192, the first layer 190 defines a first part interior divided into a plurality of regions 194 having gaps 196 between the regions. The gaps 198 define a first gap pattern. FIG. 9B shows a second layer 200 (Layer N+1) of build material deposited on the first layer 190 shown in FIG. 9A. The second layer 200 defines a second part border 202 and a second part interior 204. The second part interior 204 is substantially free of build material deposited for the second layer to define a second layer void. FIGS. 9A and 9B illustrate how embodiments of the present invention can be used for objects having complex exterior surfaces.

Although the embodiments discussed above primarily relate to selective deposition modeling, one skilled in the art will understand that similar techniques may be used for alternative additive manufacturing techniques. More particularly, rather than depositing material in a manner similar to selective deposition modeling, various embodiments of the present invention can be used to provide and selectively harden build material in layers, such that the layers of the object define the part border and part interior with gap patterns and voids. Similarly, part accuracy can be improved be isolating the internal stresses generated during the hardening of the build material.

Accordingly, the present invention provides for improved object accuracy and smoothness for various additive manufacturing techniques. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

Accordingly, the present invention provides for the production of three-dimensional objects with improved build and support materials. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

That which is claimed:

1. A method of forming a three-dimensional object from a build material, the method comprising:
depositing a first layer of build material in a build area, wherein the first layer defines a first part border and a first part interior and wherein the first part interior is divided into a plurality of regions having one or more gaps between the regions, wherein the one or more gaps between the regions define a first gap pattern; and
depositing a second layer of build material on the first layer, wherein the second layer defines a second part border and a second part interior and wherein the second part interior is divided into a plurality of regions having one or more gaps between the regions, wherein the one or more gaps between the regions define a second gap pattern,
wherein the second gap pattern is different than the first gap pattern.

2. A method according to claim 1, wherein the first gap pattern defines substantially the same shape as the second gap pattern and is shifted along at least one axis relative to the second gap pattern.

3. A method according to claim 1, wherein the first gap pattern and the second gap pattern define substantially different shapes.

4. A method according to claim 1 further comprising depositing a third layer of build material on the second layer, wherein the third layer defines a third part border and a third part interior and wherein the third part interior is divided into a plurality of regions having one or more gaps between the regions, wherein the one or more gaps between the regions define a third gap pattern that is different than the second gap pattern.

5. A method according to claim 4, wherein the third gap pattern is substantially the same as the first gap pattern.

6. A method according to claim 1, wherein the one or more gaps of the first gap pattern and of the second gap pattern define respective grids that are substantially oriented along at least one of an x-axis and y-axis of an apparatus for forming the three-dimensional object.

7. A method according to claim 1, wherein the one or more gaps of the first gap pattern and the second gap pattern define respective random shapes of gaps.

8. A method according to claim 1, wherein depositing the first layer with the first gap pattern and depositing the second layer with the second gap pattern is repeated until the three-dimensional object is formed, wherein the first layers are deposited on the second layer and the second layers are deposited on the first layers.

9. A method according to claim 1, wherein portions of layers defining up-facing and down-facing surfaces of the three-dimensional object are free of a gap pattern.

10. A method according to claim 1, wherein build material deposited for the second layer enters the one or more gaps defining the first gap pattern.

11. A method according to claim 1, wherein portions of the one or more gaps defining the first gap pattern are substantially free of build material deposited for the second layer.

12. A method according to claim 1, wherein depositing the first layer defining a first part border comprises a two-part process in which an initial part border is deposited and substantially hardened prior to a subsequent part border is deposited on the initial part border.

13. A method of forming a three-dimensional object from a build material, the method comprising:
depositing a first layer of build material in a build area, wherein the first layer defines a first part border and a first part interior and wherein the first part interior is divided into a plurality of regions having one or more gaps between the regions, wherein the one or more gaps between the regions define a first gap pattern;
depositing a second layer of build material on the first layer, wherein the second layer defines a second part border and a second part interior and wherein the second part interior is substantially free of build material deposited for the second layer to define a second layer void; and
depositing a third layer of build material on the second layer, wherein the third layer defines a third part border and a third part interior and wherein the third part interior is divided into a plurality of regions having one or more gaps between the regions, wherein the one or more gaps between the regions define a third gap pattern,
wherein the build material deposited for the third part interior substantially fills the second layer void.

14. A method according to claim 13, wherein the third gap pattern is different than the first gap pattern.

15. A method according to claim 13, wherein the one or more gaps of the first gap pattern and of the third gap pattern define respective grids that are substantially oriented along at least one of an x-axis and y-axis of an apparatus for forming the three-dimensional object.

16. A method according to claim 13, further comprising depositing a fourth layer of build material on the third layer, wherein the fourth layer defines a fourth part border and a fourth part interior and wherein the fourth part interior is substantially free of build material deposited for the fourth layer to define a fourth layer void.

17. A method according to claim 13, wherein portions of layers defining up-facing and down-facing surfaces of the three-dimensional object are free of a gap pattern and a layer void.

18. A method according to claim 13, wherein build material deposited for the third layer enters the one or more gaps defining the first gap pattern.

19. A method of forming a three-dimensional object from a build material, the method comprising:
providing a first layer of substantially liquid build material in a build area;
selectively hardening the first layer of build material, wherein the hardened first layer defines a first part border and a first part interior and wherein the first part interior is divided into a plurality of regions having one or more gaps between the regions, wherein the one or more gaps between the regions define a first gap pattern; and
providing a second layer of substantially liquid build material in contact with the hardened first layer;
selectively hardening the second layer of build material, wherein the hardened second layer defines a second part border and a second part interior and wherein the second part interior is divided into a plurality of regions having one or more gaps between the regions, wherein the one or more gaps between the regions define a second gap pattern,
wherein the second gap pattern is different than the first gap pattern.

20. A method according to claim 19, wherein selectively hardening of the second layer of build material comprises selectively hardening substantially liquid build material within the one or more gaps defining the first gap pattern.
